(19) United States
(12) Patent Application Publication
(10) Pub. No.: US 2005/0105807 A1
(43) Pub. Date: May 19, 2005

(54) Delivery of moving images according to reception condition of recipient

(76) Inventors: Tooru Suino, Kanagawa (JP); Satoshi Ouchi, Tokyo (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/944,098

(22) Filed: Sep. 17, 2004

(30) Foreign Application Priority Data
Sep. 19, 2003 (JP) 2003-327631

(51) Int. Cl. G06K 9/36

(52) U.S. Cl. 382/232

(57) ABSTRACT

An apparatus for delivering moving images to a client apparatus includes a unit configured to acquire an indication of a reception environment of the client apparatus, a block classifying unit configured to classify blocks of a still image corresponding to each frame of the moving images into one ore more blocks of interest and one or more blocks of no interest in response to importance of the respective blocks, and a coding unit configured to encode the still image corresponding to each frame of the moving images, the coding unit reducing codes with respect to the blocks of no interest ahead of the blocks of interest, wherein an amount of the code reduction is increased on a block-specific basis as the reception environment deteriorates.

The present application claims priority to the corresponding Japanese Application No. 2003-327631, filed on Sep. 19, 2003, the entire contents of which are hereby incorporated by reference.

### BACKGROUND OF THE INVENTION

1. Field of the Invention

The present invention generally relates to technologies for encoding and transmitting images, and particularly relates to an image server apparatus and a moving image delivery system for delivering moving images to a client apparatus.

2. Description of the Related Art

Japanese Patent No. 3003618 (hereinafter referred to as Patent Document 1) performs the hierarchical coding of moving images according to the levels of importance in terms of image quality, and packetizes codes separately for each hierarchical level, followed by transmitting packets successively in the order of priority, and then transmitting remaining packets in a next cycle in the order of priority if these remaining packets are not transmitted within a frame cycle. More specifically, a frame image is subjected to the Discrete Cosine Transform (DCT) on a block-by-block basis, and the DCT coefficients of each block are grouped into three frequency bands, with entropy coding carried out separately for each frequency band. The lower the frequency band, the higher the importance of DCT coefficients is. Packets having higher importance are transmitted ahead of other packets.

Japanese Patent Application Publication No. 2002-262288 (hereinafter referred to as Patent Document 2) discloses an image data transmission apparatus that reduces the amount of transmission data by performing the trimming or decimating of image data to reduce resolution or by reducing the number of bits per pixel prior to the coding of image data if transmission speed is slow.

Japanese Patent Application Publication No. 2001-45098 (hereinafter referred to as Patent Document 3) discloses a data communication system in which a data transmission apparatus on the transmission side attends to hierarchical coding of images to generate a plurality of data streams for transmission, and a data communication apparatus on the reception side monitors reception conditions such as packet loss and transmission delays to select a data stream from the plurality of data streams according to the reception conditions.

In the technology described in Patent Document 1, an entire image reconstructed on the receiver side has the image quality thereof degraded with respect to frames for which the code packets of some hierarchical levels are not received due to network congestion or the like. In order to avoid such a failure, the receiver-side apparatus needs to receive and process the packets of unreceived codes in a next or subsequent cycle in the manner as described in Patent Document 1. Because of this, the receiver-side apparatus needs to be equipped with a large reception buffer for accumulating codes for a plurality of frames. Further, there is an increasing time lag from the transmission (or reception) of a frame to the reconstruction of the frame.

In the technology described in Patent Document 2, an image reconstructed on the receiver side may have a portion thereof having been lost or may have the overall quality thereof being degraded when transmission speed is slow.

The technology described in Patent Document 3 is useful when the same images are delivered to a plurality of receiver apparatuses, and is not intended to perform image delivery that is adopted to the reception environment (e.g., at lest one of network-connection status and decoding capability) of each receiver apparatus. Further, if the receiver apparatus is situated in a bad reception environment, a reconstructed image ends up having poor overall quality.

### SUMMARY OF THE INVENTION

Delivery of moving images according to reception condition of recipient is described. In one embodiment, the delivery of moving images comprises a unit to acquire an indication of a reception environment of the client apparatus, a block classifying unit to classify blocks of a still image corresponding to each frame of the moving images into one ore more blocks of interest and one or more blocks of no interest in response to importance of the respective blocks, and a coding unit to encode the still image corresponding to each frame of the moving images. The coding unit reduces codes with respect to the blocks of no interest ahead of the blocks of interest, where an amount of the code reduction is increased on a block-specific basis as the reception environment deteriorates.

### BRIEF DESCRIPTION OF THE DRAWINGS

Other objects and further features of the present invention will be apparent from the following detailed description when read in conjunction with the accompanying drawings, in which:

FIG. 1 is a block diagram for illustrating an embodiment of the invention;

FIG. 2 is an illustrative drawing showing an example of a display screen of a display unit for providing a GUI;

FIG. 3 is an illustrative drawing for illustrating the operation timing of a client apparatus;

FIG. 4 is a flowchart showing a process performed by an image server apparatus with respect to second and following frames of moving images;

FIG. 5 is a diagram showing ranked importance levels with respect to respective blocks;

FIG. 6 is an illustrative drawing showing an example of classification based on the amount of motion;

FIG. 7 is a drawing showing an example of a reproduced image in the case of a resolution progressive method;

FIG. 8 is a drawing showing an example of a reproduced image in the case of an image quality progressive method;

FIG. 9 is a drawing showing an example of a reproduced image in the case of a component progressive method;

FIG. 10 is a drawing showing an example of a reproduced image in the case of a position progressive method;

FIG. 11 is an illustrative drawing for illustrating the resolution progressive method;

FIG. 12 is an illustrative drawing for illustrating the image quality progressive method;

FIG. 13 is another illustrative drawing for illustrating the image quality progressive method;

FIG. 14 is an illustrative drawing for illustrating the component progressive method;

FIG. 15 is an illustrative drawing for illustrating the position progressive method;

FIG. 16 is a flowchart of a coding process of JPEG2000;

FIG. 17 is an illustrative drawing showing relationships between an image, tiles, sub-bands, precincts, and code blocks;

FIG. 18 is an illustrative drawing showing an example of a layer structure in the case where the number of decomposition levels is 2, and the precinct size is equal to the sub-band size; and

FIG. 19 is an illustrative drawing showing an example of packets enclosed in thick, solid lines contained in layers.

### DESCRIPTION OF THE PREFERRED EMBODIMENTS

A moving image delivery system that delivers each frame of moving pictures from an image server apparatus (image transmitting apparatus) to a client apparatus (image receiving apparatus) is described.

Embodiments of the present invention include an image server apparatus, a moving image delivering method, and a client apparatus for use in such a moving image delivery system that substantially obviates one or more problems caused by the limitations and disadvantages of the related art.

Embodiments of the invention also include an image server apparatus and a moving image delivering method that control the coding of each frame of moving images according to the reception environment (at least one of network-connection status and decoding status) of recipient client apparatuses, and that control a coding process such as to provide for each frame of moving images to be reconstructed with high quality for at least its main portion without degrading overall image quality even if the client apparatus is situated in a poor reception environment.

One embodiment of the invention includes a client apparatus that can reconstruct images without having a frame loss in the case of streaming delivery of moving images, without a need for a large receiving buffer for accumulating the codes of a plurality of frames.

Another embodiment of the invention includes an image server apparatus and a client apparatus equipped with a control means that provides for the client apparatus to control a portion to be reconstructed with high quality.

Features and advantages of the present invention will be presented in the description which follows, and in part will become apparent from the description and the accompanying drawings, or may be learned by practice of the invention according to the teachings provided in the description. Objects as well as other features and advantages of the present invention will be realized and attained by an apparatus, a method, and a system particularly pointed out in the specification in such full, clear, concise, and exact terms as to enable a person having ordinary skill in the art to practice the invention.

To achieve these and other advantages in accordance with a purpose of the invention, one embodiment of the invention includes an apparatus for delivering moving images to a client apparatus, including a unit configured to acquire an indication of a reception environment of the client apparatus, a block classifying unit configured to classify blocks of a still image corresponding to each frame of the moving images into one ore more blocks of interest and one or more blocks of no interest in response to importance of the respective blocks, and a coding unit configured to encode the still image corresponding to each frame of the moving images, the coding unit reducing codes with respect to the blocks of no interest ahead of the blocks of interest, wherein an amount of the code reduction is increased on a block-specific basis as the reception environment deteriorates.

According to one embodiment of the invention, the coding unit is configured to increase a difference in an amount of code reduction between the blocks of interest and the blocks of no interest as the reception environment deteriorates.

According to one embodiment of the invention, the block classifying unit is configured to increase a number of the blocks of no interest as the reception environment deteriorates.

According to one embodiment of the invention, the coding unit is configured to increase a difference in an amount of code reduction between the blocks of interest and the blocks of no interest as the reception environment deteriorates if the coding unit generates codes according to one of a resolution progressive method, an image quality progressive method, and a component progressive method, and the block classifying unit is configured to increase a number of the blocks of no interest as the reception environment deteriorates if the coding unit generates codes according to a position progressive method.

According to one embodiment of the invention, the block classifying unit assigns the importance to the blocks of the still image such that the importance increases towards a center of the still image.

According to one embodiment of the invention, the block classifying unit assigns the importance to the blocks of the still image such that the larger an amount of motion in a given block, the larger the importance in the given block is.

According to one embodiment of the invention, the apparatus as described above further includes a unit configured to acquire an instruction regarding block importance from the client apparatus, wherein the block classifying unit assigns the importance to the blocks of the still image according to the instruction.

According to one embodiment of the invention, the apparatus as described above further includes a unit configured to acquire an instruction regarding the difference in the amount of code reduction between the blocks of interest and the blocks of no interest, wherein the coding unit controls the difference in the amount of code reduction between the blocks of interest and the blocks of no interest according to the instruction.

According to one embodiment of the invention, the instruction is given independently for each of the blocks.

According to one embodiment of the invention, the apparatus as described above further includes a unit configured to acquire an instruction regarding a difference in a number of blocks between the blocks of interest and the blocks of no interest, wherein the block classifying unit controls the difference in the number of blocks between the blocks of interest and the blocks of no interest according to the instruction.

According to one embodiment of the invention, the instruction is given independently for each of the blocks.

According to one embodiment of the invention, the apparatus as described above further includes a unit configured to acquire a first instruction regarding block importance from the client apparatus, a unit configured to acquire a second instruction regarding the difference in the amount of code reduction between the blocks of interest and the blocks of no interest, and a unit configured to acquire a third instruction regarding a difference in a number of blocks between the blocks of interest and the blocks of no interest, wherein the block classifying unit assigns the importance to the blocks of the still image according to the first instruction, the coding unit controlling the difference in the amount of code reduction between the blocks of interest and the blocks of no interest according to the second instruction if the coding unit generates codes according to one of the resolution progressive method, the image quality progressive method, and the component progressive method, and the block classifying unit controlling the difference in the number of blocks between the blocks of interest and the blocks of no interest according to the third instruction if the coding unit generates codes according to the position progressive method.

According to one embodiment of the invention, the apparatus as described above further includes a unit configured to acquire an instruction regarding a progressive method, wherein the coding unit generates codes according to a progressive method corresponding to the instruction.

According to one embodiment of the invention, the reception environment includes at least one of a state of a network connection with the client apparatus and a decoding capability of the client apparatus.

According to one embodiment of the invention, an apparatus for receiving moving images from the apparatus as described above includes a graphical user interface configured to display a field to receive the first instruction, the second instruction, and the third instruction.

According to one embodiment of the invention, a system includes the apparatus for delivering moving images as described above, and the apparatus for receiving the moving images as described above.

According to one embodiment of the invention, a method of delivering moving images to a client apparatus includes the steps of classifying blocks of a still image corresponding to each frame of the moving images into one ore more blocks of interest and one or more blocks of no interest in response to importance of the respective blocks, and encoding the still image corresponding to each frame of the moving images while reducing codes with respect to the blocks of no interest ahead of the blocks of interest, wherein an amount of the code reduction is increased on a block-specific basis as a reception environment of the client apparatus deteriorates.

According to one embodiment of the invention, the step of encoding increases a difference in an amount of code reduction between the blocks of interest and the blocks of no interest as the reception environment deteriorates.

According to one embodiment of the invention, the step of classifying increases a number of the blocks of no interest as the reception environment deteriorates.

According to one embodiment of the invention, the step of encoding increases a difference in an amount of code reduction between the blocks of interest and the blocks of no interest as the reception environment deteriorates if the step of encoding generates codes according to one of a resolution progressive method, an image quality progressive method, and a component progressive method, and the step of classifying increases a number of the blocks of no interest as the reception environment deteriorates if the step of encoding generates codes according to a position progressive method.

According to one embodiment of the invention, a computer-readable record medium having a program embodied therein for causing a computer to deliver moving images to a client apparatus is provided. The program is configured to cause the computer to perform the steps of classifying blocks of a still image corresponding to each frame of the moving images into one ore more blocks of interest and one or more blocks of no interest in response to importance of the respective blocks, and encoding the still image corresponding to each frame of the moving images while reducing codes with respect to the blocks of no interest ahead of the blocks of interest, wherein an amount of the code reduction is increased on a block-specific basis as a reception environment of the client apparatus deteriorates.

According to one embodiment of the invention, the step of encoding increases a difference in an amount of code reduction between the blocks of interest and the blocks of no interest as the reception environment deteriorates.

According to one embodiment of the invention, the step of classifying increases a number of the blocks of no interest as the reception environment deteriorates.

According to one embodiment of the invention, the step of encoding increases a difference in an amount of code reduction between the blocks of interest and the blocks of no interest as the reception environment deteriorates if the step of encoding generates codes according to one of a resolution progressive method, an image quality progressive method, and a component progressive method, and the step of classifying increases a number of the blocks of no interest as the reception environment deteriorates if the step of encoding generates codes according to a position progressive method.

According to at least one embodiment of the invention, when the reception environment of the client apparatus deteriorates due to a worsening state of a network connection, the code amount of a frame is adjusted by controlling the amount of code reduction or the number of the block of no interest in response to the reception environment. This provides for the client apparatus to reproduce images without frame loss. The quality of reproduction (resolution, image quality, color reproduction, etc.) of each video frame does not degrade for an entirety of the image, and at least a main portion (i.e., a main object or a high-speed moving object in the image) is reproduced with high quality. Since the image server apparatus adjusts the amount of codes of each frame in response to the reception environment of the client apparatus, real-time image reproduction is achievable in the case of streaming delivery of moving images, without a need for a large receiving buffer provided in the client apparatus for storing codes equal in amount to two or more frames.

According to at least one embodiment of the invention, further, a portion that is to be reproduced with high quality or a difference in image quality between high-quality portions and other portions are selectable at the client apparatus. Such selection may be readily made through a graphical user interface.

According to at least one embodiment of the invention, the amount of codes is adjusted according to a progressive method. In the case of the resolution progressive method, codes are reduced such as to lower resolution gradually. In the case of the image quality progressive method, codes are reduced such as to lower image quality gradually. In the case of the component progressive method, codes are reduced such as to decrease color components gradually. In the case of the position progressive method, codes are reduced such as to expand areas gradually where image quality, resolution, or the like is lowered. Such a progress method may be selected at the client apparatus.

In the following, embodiments of the present invention will be described with reference to the accompanying drawings.

With respect to moving images used in the embodiments of the invention as will be described in the following, still images constituting respective frames are encoded and decoded according to the JPEG2000 algorithm. A description will thus be given of the outline of JPEG2000 first, prior to the description of the embodiments. It should be noted that JPEG2000 is a preferred but non-limiting example, and other coding algorithms may as well be used in the present invention.

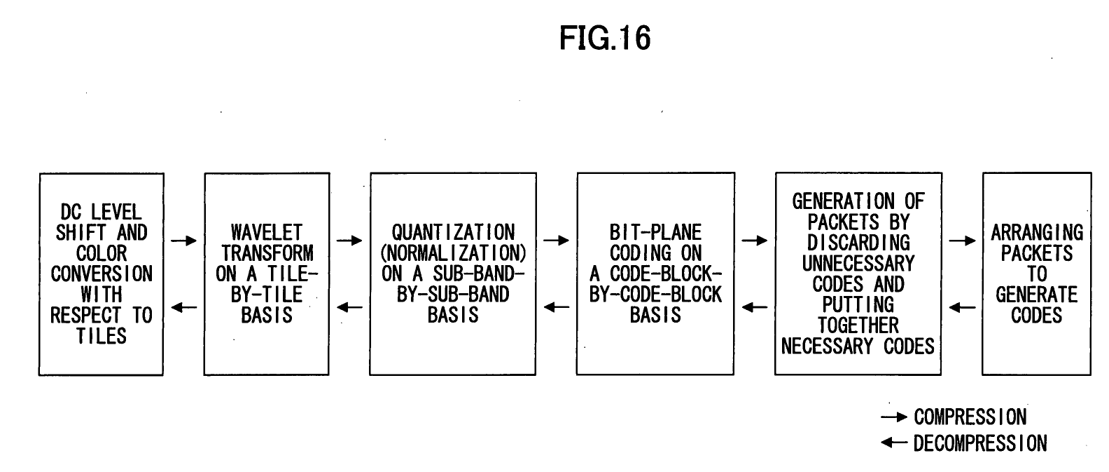

FIG. 16 is a flowchart of a coding process of JPEG2000.

When a color image comprised of the three components RGB is to be encoded, each component is divided into non-overlapping tiles, and each tile is processed separately in each component. The size of a tile is user-selectable, and may be selected such as to be equal to the size of the image. That is, it is possible to perform no tile division.

DC level shift and color conversion into luminance and color difference components are performed separately for each tile. It should be noted that such DC level shift and color conversion are not essential.

Thereafter, the wavelet transform (discrete wavelet transform) is performed separately for each tile of each component. In JPEG2000, the 5×3 reversible wavelet transform and the 9×7 irreversible wavelet transform are available as the wavelet transform. The number of decomposition levels of the wavelet transform (i.e., how many times the wavelet transform is applied: the number of hierarchical levels) is user-selectable.

Entropy coding of wavelet coefficients is performed separately for each sub-band (after linear quantization when the 9×7 wavelet transform is used). In order to raise compression efficiency, generally, the wavelet coefficients are grouped into bit-planes, and the entropy coding is performed on a bit-plane-specific basis (bit-plane coding). To be exact, each bit-plane is divided into three sub-bit-planes to be encoded (sub-bit-plane coding).

Unnecessary codes are truncated (discarded) from the obtained codes, and necessary codes are put together to generate packets. The packets are arranged in a predetermined sequence, with a relevant tag or tag information attached thereto, thereby generating a code stream having a predetermined format.

Decoding is an exact inverse of the coding. A code stream is divided into the code streams of individual tiles of individual components, and is converted back into wavelet coefficients by entropy decoding. The wavelet coefficients are dequantized if quantization is performed at the time of encoding, and is then subjected to the inverse wavelet transform for conversion into pixel values. If the DC level shift and color conversion are applied at the time of coding, inverse color conversion and inverse DC level shift are applied to the pixel values after the inverse wavelet transform, thereby generating original RGB pixel values.

In the following, a description will be given of entropy coding, packet generation, and code generation at the time of coding.

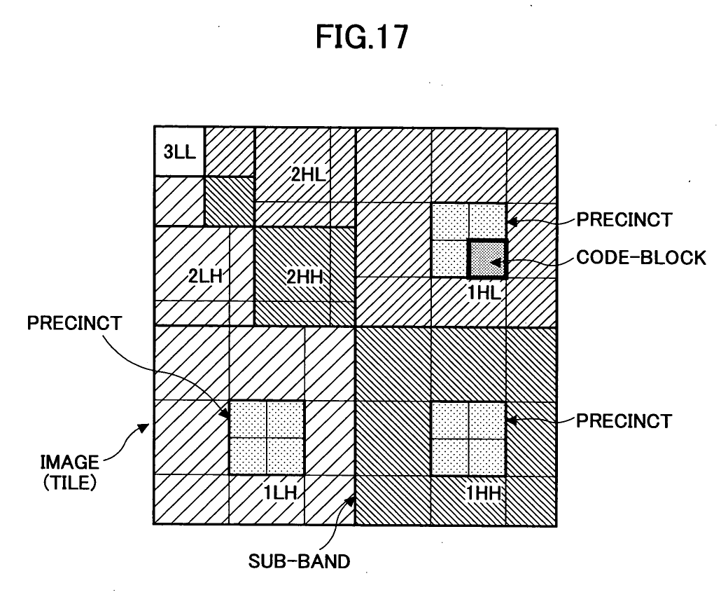

FIG. 17 is an illustrative drawing showing the relationships between an image, tiles, sub-bands, precincts, and code blocks. In this example, the tile size and the image size are the same (the number of tile divisions=1). The number of decomposition levels of the wavelet transform is 3. Sub-bands include sub-bands 1LH, 1HL, and 1HH at the decomposition level 1, sub-bands 2LH, 2HL, and 2HH at the decomposition level 2, and sub-bands 3LL, 3LH, 3HL, and 3HH at the decomposition level 3.

Precincts are rectangles (having user-selectable size) into which a sub-band is divided, and indicate general location within the image. As for the precincts obtained by dividing the sub-bands HL, LH, and HH, three precincts located at the same relative position within each of these three sub-bands are treated together as a single entity. Precincts obtained by dividing the sub-band LL are each treated as a single entity. The size of a precinct can be set equal to the size of a sub-band. A precinct is divided into rectangular areas (having user-selectable size) called code blocks. The coefficients of a sub-band are encoded separately for each code-block.

A portion of the codes of all the code blocks contained in a precinct (e.g., codes of the three bit-planes from the MSB bit-plane to the third bit-plane of all the code blocks) may be combined together to form a packet.

Further, a layer structure is available in JPEG2000. If packets are combined with respect to all the precincts (i.e., all the code blocks, i.e., all the sub-bands), a portion of the codes of the entire image (e.g., the codes of the MSB bit-plane through the third bit-plane of the wavelet coefficients corresponding to the entire image) is obtained. This is called a layer. Roughly speaking, the layer is a portion of the codes of bit-planes corresponding to the entire image. The larger the number of layers that are decoded, the better the quality of a reproduced image is. That is, a layer defines the unit of image quality.

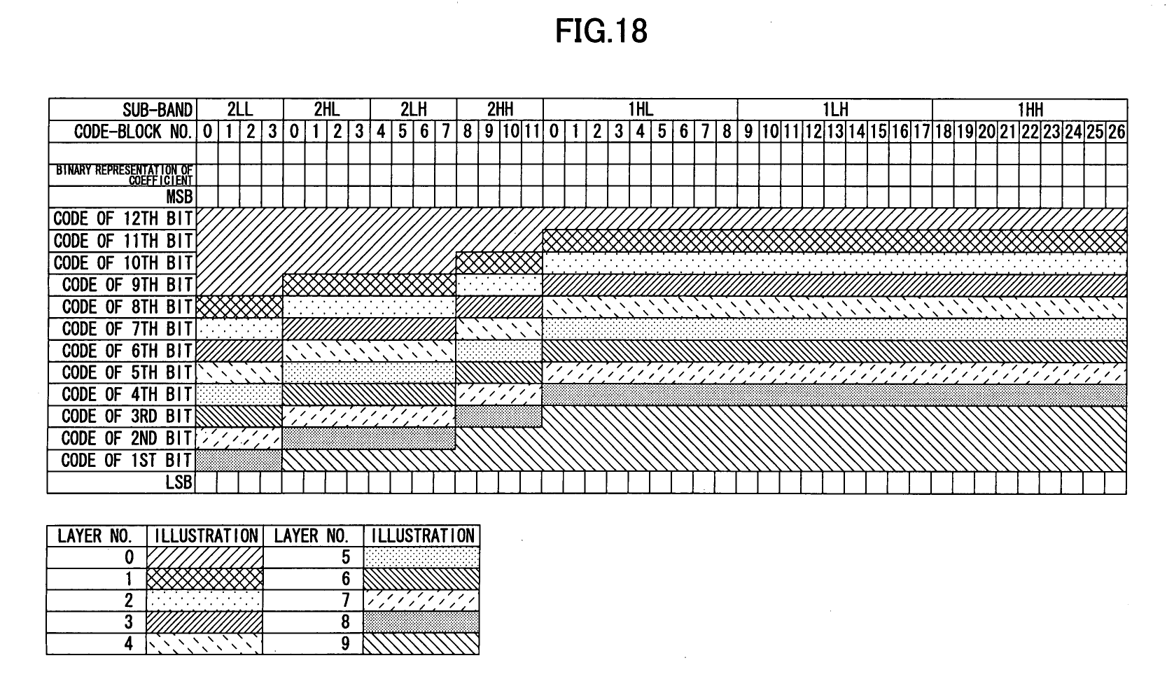

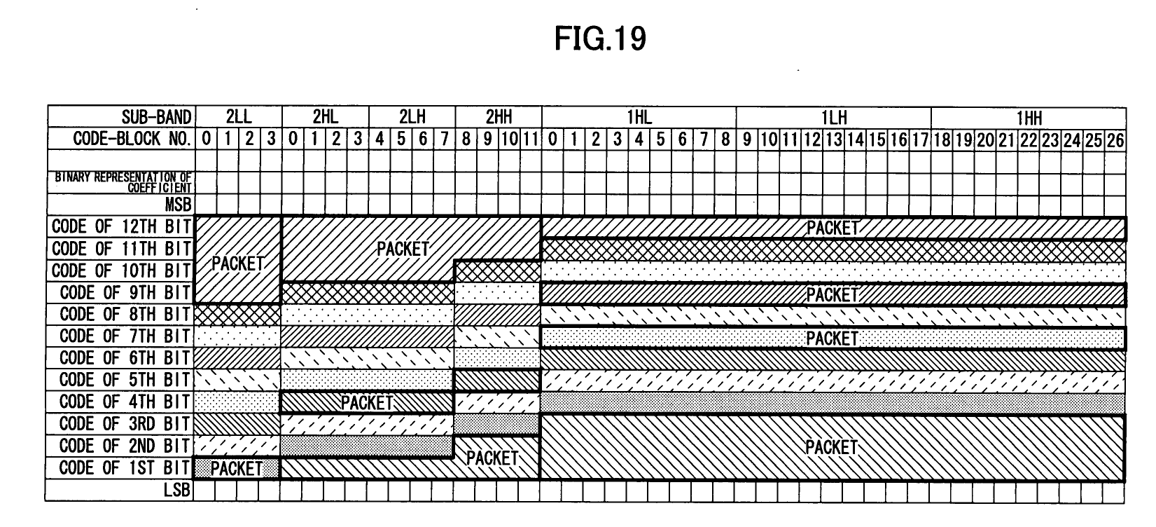

FIG. 18 is an illustrative drawing showing an example of a layer structure in the case where the number of decomposition levels (the number of hierarchical levels) is 2, and the precinct size is equal to the sub-band size. FIG. 19 is an illustrative drawing showing an example of packets enclosed in thick, solid lines contained in layers. In this example, the precinct size is equal to the sub-band size, and the size of a code block is the same as the size of a precinct. Because of this, a sub-band at the decomposition level 2 is divided into four code blocks, and a sub-band at the decomposition level 1 is divided into nine code blocks. Since a packet is provided in the units of precincts, a packet extends across the sub-bands HL through HH where a precinct is equal to a sub-band.

A packet is a combined set of codes that are extracted from code blocks and correspond to part of the code blocks, and there is no need to generate a packet for unnecessary codes. For example, the codes of a lower-order bit-plane such as a layer 9 are generally discarded (truncated). The control of image quality through such truncation may be performed separately for each code block (on a sub-bit-plane-specific basis). That is, the control of image quality through truncation is carried out on a code-block-by-code-block basis.

Moreover, JPEG2000 provides for various control to be performed with respect to a packet generation method and the sequence of arranged packets, and may generate codes according to a resolution progressive method, an image progressive method, a component progressive method, or a position progressive method.

In one embodiment of the present invention, code reduction is performed for the purpose of adjusting the amount of codes. Such code reduction may be done by the truncation of cedes at the packet generation stage and/or at the code generation stage shown in FIG. 16 and/or by the truncation of codes after code generation. Substantial truncation of codes can also be done by discarding coefficients at the bit-plane coding stage. It is an advantage of JPEG2000 that flexible adjustment of code amount is possible at various stages without a need for second-time encoding. This is one of the reasons why JPEG2000 is selected for use in the embodiments of the present invention.

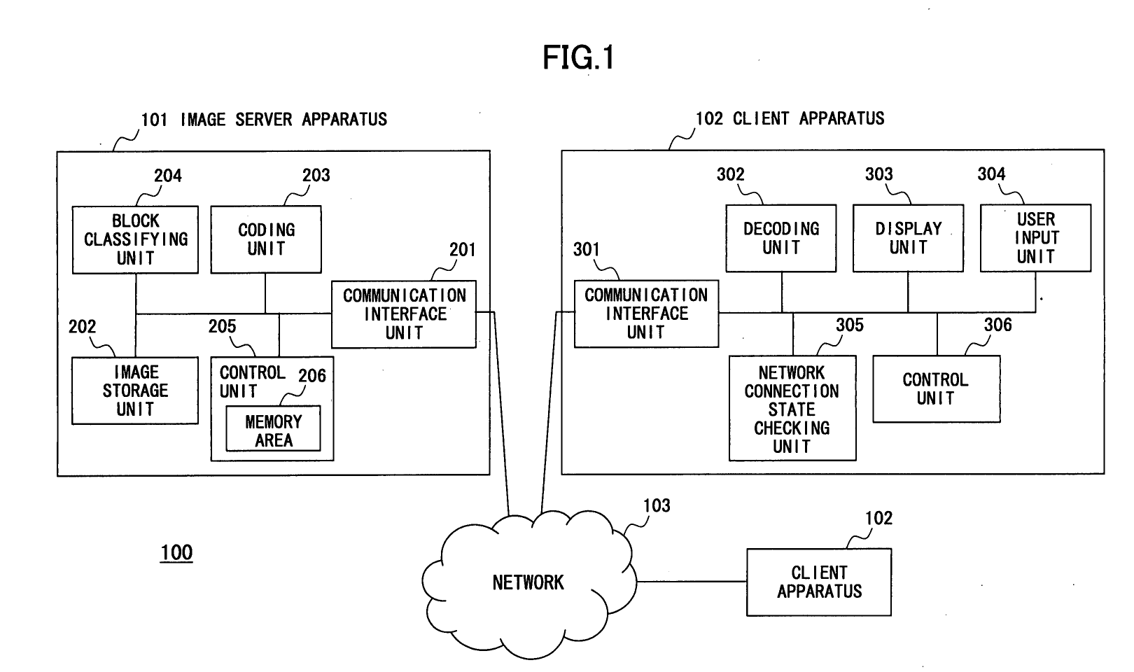

In the following, a description will be given of preferred embodiments of the invention. FIG. 1 is a block diagram for illustrating an embodiment of the invention.

A moving image delivery system 100 of one embodiment of the invention includes an image server apparatus 101 and a plurality of client apparatuses 102 connected through a network 103 (e.g., the Internet, a LAN, or an intranet). The image server apparatus 101 is configured to encode moving images and to provide a streaming delivery service to the client apparatuses 102.

The image server apparatus 101 includes a communication interface unit 201 for communicating with the client apparatuses 102 through the network 103, an image storage unit 202 for storing moving image data, a coding unit 203 for encoding moving image data, a block classifying unit 204 for performing block classification relating to code reduction at the time of coding, and a control unit 205 for controlling each of the units and managing various messages received from the client apparatuses 102.

From the client apparatuses 102, messages are received, including an indication of a reception environment, an instruction regarding a progressive method, an instruction regarding the importance of blocks, an instruction regarding the degree of difference in the amount of code reduction, and an instruction regarding the degree of difference in the number of blocks, etc. The contents of the received messages are stored in a memory area 206 of the control unit 205. That is, the control unit 205 together with the communication interface unit 201 serve as a means to store received information. The data contents stored in the memory area 206 is accessed by the coding unit 203 and the block classifying unit 204.

A client apparatus 102 includes a communication interface unit 301 for communicating with the image server apparatus 101 through the network 103, a decoding unit 302 for decoding the coded data (code streams) of received moving images, a display unit 303 for displaying decoded images and providing user interface, a user input unit 304 such as a pointing device, a network connection state checking unit 305 for checking the state of network connections based on packet loss and transmission delays, and a control unit 306 for generating messages to be transmitted to the image server apparatus 101 and for controlling transmission and the operation of each of the units.

Messages generated by the control unit 306 for transmission include an indication of a reception environment, an instruction regarding a progressive method, an instruction regarding the importance of blocks, an instruction regarding the degree of difference in the amount of code reduction, and an instruction regarding the degree of difference in the number of blocks, etc.

The reception environment refers to the condition of a capability of decoding and displaying delivered moving images in real-time. To be specific, the reception environment may be indicated by use of the state of a network connection checked by the network connection state checking unit 305, decoding capability (the processing speed of the decoding unit 302, the size of a receiving buffer and a work memory, etc.), or both of them. Where the speed of communication is slow so that the state of a network connection controls the reception capability, only the state of a network connection may properly be used as a reception environment. Where the speed of communication is fast so that the decoding capability controls the reception capability, the decoding capability may properly be used as a reception environment. Where both the state of a network connection and the decoding capability need to be taken into account, both of these may be used as a reception environment. What sort of reception environment is to be employed may be selected by each of the client apparatuses 102. The instructions described above will be described later in detail.

The client apparatus 102 provides a graphical user interface (GUI) for exchanging various instructions. An example will be described in the following.

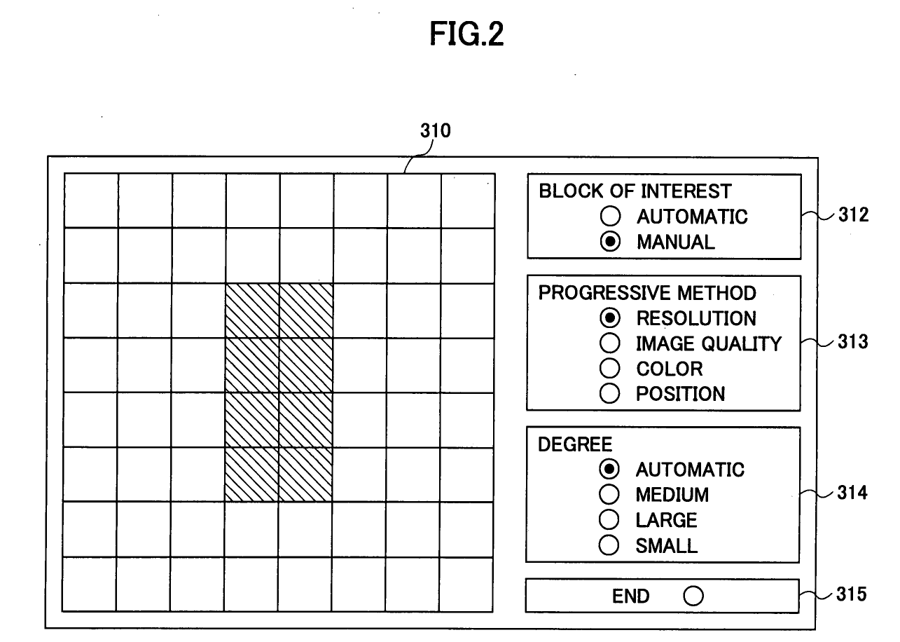

FIG. 2 is an illustrative drawing showing an example of the display screen of the display unit 303 for providing a GUI. In FIG. 2, an image display area 310 is shown. A field 312 is used by a user to select a method of determining a block of interest, and includes an “automatic” button and a “manual” button in this example. A field 313 is used by the user to select a progressive method, and includes a “resolution” button (for selecting the resolution progressive method), an “image quality” button (for selecting the image quality progressive method), a “color” button (for selecting the component progressive method), and a “position” button (for selecting the position progressive method) in this example. A field 314 is used by the user to specify the degree of difference in the amount of code reduction between the block of interest and another block, or the degree of difference in the number of blocks between the blocks of interest and other blocks (blocks of no interest), and includes “automatic”, “small”, “middle”, and “large” buttons in this example. A field 315 is used for the purpose of finishing the session of user inputting operations.

When delivering moving images to a client apparatus 102, the image server apparatus 101 encodes the first frame of moving pictures by treating all the blocks as a block of interest, and generates codes according to a predetermined progressive method for transmission. Transmission of the second and following frames is started after the client apparatuses 102 gives an instruction.

In the client apparatus 102, the decoding unit 302 decodes the first frame, and the decoded image is displayed in an image display area 310 on the screen of the display unit 303. Superimposed on the image, block dividing lines (grid lines in FIG. 2) are also displayed. In this embodiment, tile division is performed at the time of coding, and each tile is treated as a block. Accordingly, the block dividing lines correspond to tile dividing lines. Alternatively, smaller areas such as precincts may be treated as blocks. When the second and following frames are processed, the block dividing lines are not displayed, and only each of the frames of moving images is displayed.

The user of the client apparatus 102 may choose either the “automatic” button or the “manual” button in the field 312. If the user selects the “automatic” button, the image server apparatus 101 automatically evaluates the weight of blocks to determine the block of interest (i.e., classifies blocks into the blocks of interest and other blocks).

If the “manual” button is selected, the user may specify a block that appears to be important on the image display area 310. For example, the user may move the mouse pointer to a block and click the block to select it. The selection of the block may be cancelled by clicking the block again. Blocks selected in this manner are given a higher level of importance, and other blocks are given a lower level of importance. It should be apparent that three or more different levels of importance may be given to blocks by modifying the GUI. Such modification is intended to be part of one embodiment of the invention.

The user may specify a progressive method by selecting a button in the field 313, and may specify a “degree” by selecting a button in the field 314. The image server apparatus 101 increases a difference in the amount of code reduction between the block of interest and other blocks as the reception environment of the recipient client apparatus 102 exacerbates, or increases a difference in the number of blocks between the block of interest and other blocks as the reception environment of the recipient client apparatus 102 exacerbates. The indication of above-noted “degree” specifies the size of such difference. The detail of such indication differs depending on a progressive method.

When the resolution progressive method, the image quality progressive method, or the component progressive method is chosen, an indication of “degree” relates to a difference in the amount of code reduction between the blocks of interest and other blocks (blocks of no interest). That is, the selecting of the “automatic” button makes it possible to specify that the degree of difference in the amount of code reduction is determined according to criteria given by the image server apparatus 101. Further, the selecting of the “small”, “middle”, or “large” button makes it possible to set the degree of difference in the amount of code reduction to a small, middle, or large level. Alternatively, a slide bar may be used in place of buttons.

The selection of “small”, “middle”, or “large” may be made separately for each block. For example, “small” may be selected together with a block selection, thereby indicating the “small” level for the selected block. In the same manner, “middle” or “large” may be selected on a block-specific basis.

On the other hand, when the position progressive method is chosen, an indication of “degree” relates to a difference in the number of blocks between the blocks of interest and the blocks of no interest. That is, the selection of the “automatic” button results in a difference in the number of blocks being determined according to criteria given by the image server apparatus 101. The selection of a “small”, “middle”, or “large” button sets the degree of a difference in the amount of code reduction to a small, middle, or large level.

The GUI is not limited to this example, and various modifications may be made.

After the user finishes giving necessary instructions by use of the GUI, the user clicks the end button 315 to enter an end instruction. Alternatively, the user may press the return key on the keyboard to enter an end instruction.

In response to the end instruction, the control unit 306 of the client apparatus 102 generates a message indicative of user instructions and the reception environment (e.g., the state of a network connection checked by the network connection state checking unit 305), and transmits the message to the image server apparatus 101 through the communication interface 301. Also, a request for the delivery of the second and following frames of moving images is transmitted. According to the various instructions and the reception environment received from the client apparatuses 102, the image server apparatus 101 controls a coding process for the second and following frames of moving images, and transmits the generated coded data to the client apparatuses 102. It should be noted that a message indicative of the reception environment is newly transmitted to the image server apparatus 101 in each frame cycle after the second and following frames of moving images.

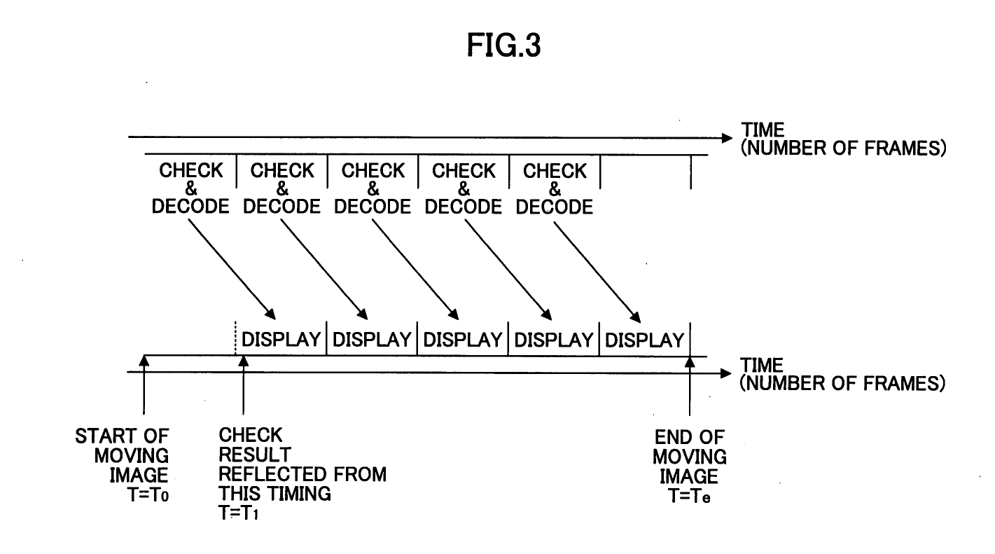

FIG. 3 is an illustrative drawing for illustrating the operation timing of the client apparatus 102 described above. The first frame of moving images is received at the time T=T0, followed by the decoding and displaying of the image. After the time T=T1 at which the setting of various instructions as described above is finished, the checking of the state of a network connection is repeated in frame cycles. The reception environment such as the state of a network connection is transmitted to the image server apparatus 101, and the decoding and displaying of received frames is carried out. The image server apparatus 101 attends to a coding process responsive to the current reception environment on a frame-by-frame basis such that the client apparatus 102 can decode and display each frame within a frame cycle. With this provision, it is possible to view smooth video images with no frame skipping in real-time video delivery even if the sate of a network connection deteriorates in the middle of delivery. This is achieved without a need for a large receiving buffer in the client apparatuses 102. Even when the reception environment gets worse due to the deterioration of the state of a network connection, the quality of an image does not degrade for the entirety of the image, and proper quality is maintained at least for an important portion corresponding to the blocks of interest. This will be described below.

In the following, the image server apparatus 101 will be described in detail.

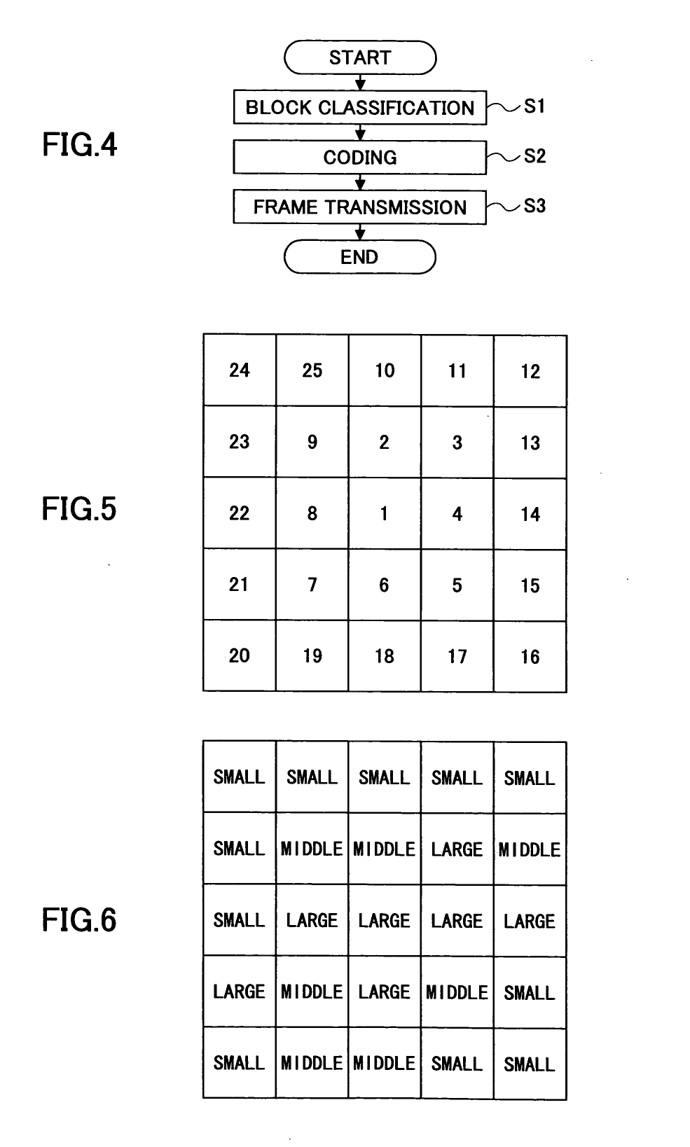

FIG. 4 is a flowchart showing a process performed by the image server apparatus 101 with respect to the second and following frames of moving images. The block classifying unit 204 classifies the individual blocks (individual tiles in this example) of a still image constituting a frame into the blocks of interest and the blocks of no interest according to priority (step S1). Thereafter, the coding unit 203 performs the coding of the frame (step S2). At the end, the generated coded data (code streams) are transmitted (step S3). In the following, a description will be given with regard to the detail of steps S1 and S2 and the construction of the apparatus.

The block classifying unit 204 classifies the blocks (i.e., tiles obtained by tile division as described above) of a still image of each video frame into the blocks of interest and the blocks of no interest according to the respective levels of importance, and provides information about such classification to the coding unit 203. The control unit 205 stores the instructions and reception environment received from the client apparatus 102 in the memory area 206. The control unit 205 also refers to the reception environment, an indication of the importance of blocks, an indication of a difference in the number of blocks between the blocks of interest and the blocks of no interest, and an indication of a progressive method by accessing the block classifying unit 204. The reception processing environment is updated for each frame.

When “automatic” about block importance is indicated by the client apparatus 102, the block classifying unit 204 evaluates the importance of each block based on the preset criteria. A specific example of such evaluation will be given below.

In one embodiment, a table as shown in FIG. 5 is prepared in advance, indicating ranked importance levels with respect to respective blocks. In the table of FIG. 5, a block to which the number “1” is assigned has the highest importance, and a block to which the number “25” is assigned has the lowest importance. In this example, the highest importance is given to the block at the center of the image, and the importance level drops toward the periphery along a spiral-form path. The block classifying unit 204 chooses blocks of interest from the blocks having higher importance according to the ranking.

In another embodiment, the amount of motion is detected in each block, and is classified into three levels, i.e., a high level, a middle level, and a low level. FIG. 6 is an illustrative drawing showing an example of classification based on the amount of motion. In blocks where the amount of motion is large, the deterioration of image quality is significant if the compression rate is high. In consideration of this, the block classifying unit 204 attaches higher importance to a block having a larger amount of motion, and attaches lower importance to a block having a smaller amount of motion. Then, the blocks of interest are chosen from blocks having higher importance.

A method of detecting the amount of motion in each block may vary. For example, a method of taking a frame difference for every block may be used. If a still image of each video frame is a composite of interlaced images corresponding to odd and even fields, the amount of motion can be detected based on wavelet transform coefficients that are obtained during a coding process. The detail of such method is disclosed in Japanese Patent Application Publication No. 2002-64830, Japanese Patent Application No. 2002-289807, Japanese Patent Application No. 2002-300468, Japanese Patent Application No. 2002-300476, and Japanese Patent Application No. 2002-360809. Briefly speaking, an effect of “comb” caused by motion between the fields appears strongly in the 1LH sub-band coefficients, and this fact is utilized to detect the amount of motion.

In yet another embodiment, the magnitude of edges is detected in each block, and character blocks and image blocks are identified based on the detected magnitude of edges, with the character blocks given higher importance and the image blocks given lower importance. Within the character blocks or within the image blocks, the larger the magnitude of edges, the higher the given importance is.

When an instruction for “manual” block importance is given from the client apparatus 102, the block classifying unit 204 evaluates the importance of blocks according to the instruction. For example, blocks specified by the user of the client apparatus 102 (hatched blocks in FIG. 2) are given the highest importance. Provision is then made to decrease the level of importance of a given block as a distance from these blocks to the given block increases. Blocks having higher importance are classified as blocks of interest, ahead of blocks having lower importance.

If the position progressive method is selected as a progressive method, the block classifying unit 204 increases the number of blocks of no interest as the reception environment exacerbates, thereby increasing a difference in the number of blocks between the blocks of interest and the blocks of no interest. In so doing, the blocks of interest are converted into the blocks of no interest in an ascending order of importance levels. The amount that the difference in the number of blocks increases is controlled according to the relevant instruction. If “automatic” is selected for “degree”, the block classifying unit 204 increases a difference in the number of blocks according to a predetermined standard degree. If “small”, “middle”, or “large” is selected for “degree”, a difference in the number of blocks is increased according to the selected degree.

The coding unit 203 serves to perform a coding process with respect to each frame according to the JPEG2000 algorithm. In order to provide for the client apparatus 102 to decode and display each frame in a frame cycle, code reduction is performed to adjust the amount of codes in each frame. Such code reduction is applied to the blocks of no interest ahead of the blocks of interest. The reception environment and other instructions stored in the memory area 206 of the control unit 205 are accessible from the coding unit 203.

The coding unit 203 generates codes conforming to the progressive method specified by the client apparatus 102. When the resolution progressive method, the image quality progressive method, or the component progressive method is selected, the coding unit 203 controls code reduction such that the worse the reception environment, the larger a difference in the amount of code reduction between the blocks of interest and the blocks of no interest. How much a difference in the amount of code reduction increases is controlled according to the relevant instruction. If “automatic” is selected for “degree”, the block classifying unit 204 increases a difference in the amount of code reduction according to a predetermined standard degree. If “small”, “middle”, or “large” is selected for “degree”, a difference in the amount of code reduction is increased according to the selected degree. It should be noted that the codes of color-difference components are reduced ahead of other codes in the case of the component progressive method.

When the position progressive method is selected as a progressive method, the amount of code reduction is not controlled as described above. The difference in the amount of code reduction between the blocks of interest and the blocks of no interest stays constant regardless of the reception environment. This is because the amount of codes is adjusted by controlling the number of blocks of no interest. Even in this case, however, a difference in the amount of code reduction may as well be adjusted in response to the reception environment. Such modification is intended to be part of the invention.

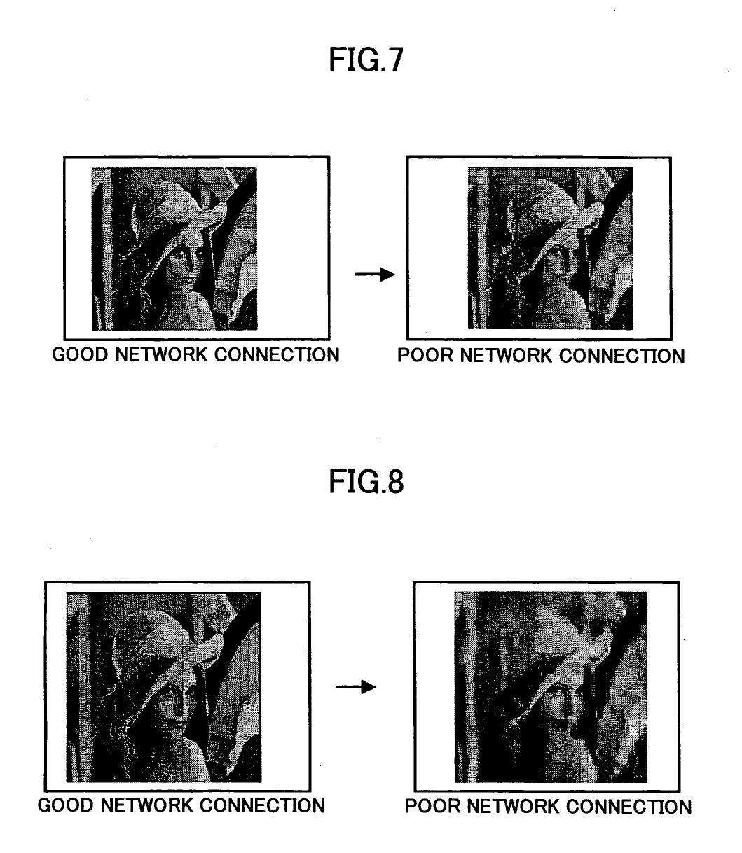

With reference FIG. 7 through FIG. 10, a description will be given of the quality of a reproduced image with respect to each progressive method in the case of a good state of network connection and in the case of a poor state of network connection.

FIG. 7 is a drawing showing an example of a reproduced image in the case of the resolution progressive method. When the state of a network connection is good, resolution is satisfactory in all blocks as shown on the left-hand side, providing an image that is entirely clear. When the state of a network connection is poor, the blocks of interest (corresponding to a face portion in this example) maintain satisfactory resolution as shown on the right-hand side since the amount of code reduction is zero or small. In other blocks, the amount of code reduction is large, resulting in unclear image portions having lower resolution. In this manner, the quality of an image as a whole may deteriorate, but the important face portion maintains good quality.

FIG. 8 is a drawing showing an example of a reproduced image in the case of the image quality progressive method. When the state of a network connection is good, image quality is satisfactory in all blocks as shown on the left-hand side, providing high quality for every portion of the image. When the state of a network connection is poor, the blocks of interest (corresponding to a face portion in this example) maintain high image quality as shown on the right-hand side since the amount of code reduction is zero or small. In other blocks, the amount of code reduction is large, resulting in low quality. In this manner, the quality of an image as a whole may deteriorate, but the important face portion maintains good quality.

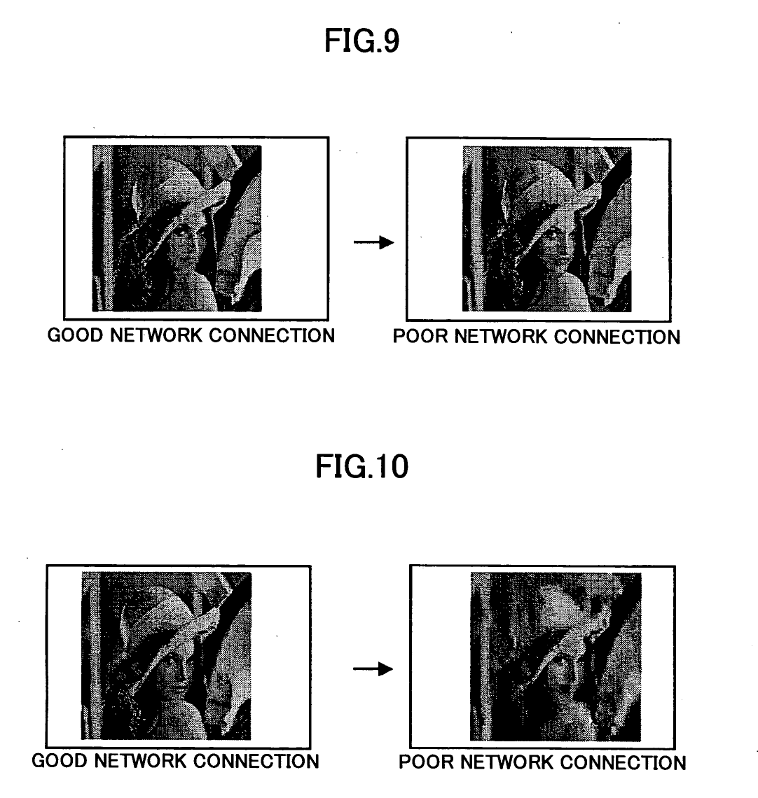

FIG. 9 is a drawing showing an example of a reproduced image in the case of the component progressive method. When the state of a network connection is good, color reproduction is satisfactory in all blocks as shown on the left-hand side (due to the limitation of illustration, colors are not represented). When the state of a network connection is poor, the blocks of interest (corresponding to a face portion in this example) maintain proper color reproduction as shown on the right-hand side since the amount of code reduction is zero or small with respect to the color-difference codes. In other blocks, the color-difference codes are entirely discarded, resulting in black and white reproduction. It is possible to discard a portion of the color-difference codes in the blocks of no interest. This results in an unnatural appearance of colors.

FIG. 10 is a drawing showing an example of a reproduced image in the case of the position progressive method. When the state of a network connection is good, all the blocks are treated as blocks of interest, so that every portion of the image has high quality as shown on the left-hand side. When the state of a network connection is poor, the number of blocks of no interest increases. The blocks of interest (corresponding to a face portion in this example) maintain high image quality as shown on the right-hand side since the amount of code reduction is zero or small. In other blocks, the amount of code reduction is large, resulting in low quality.

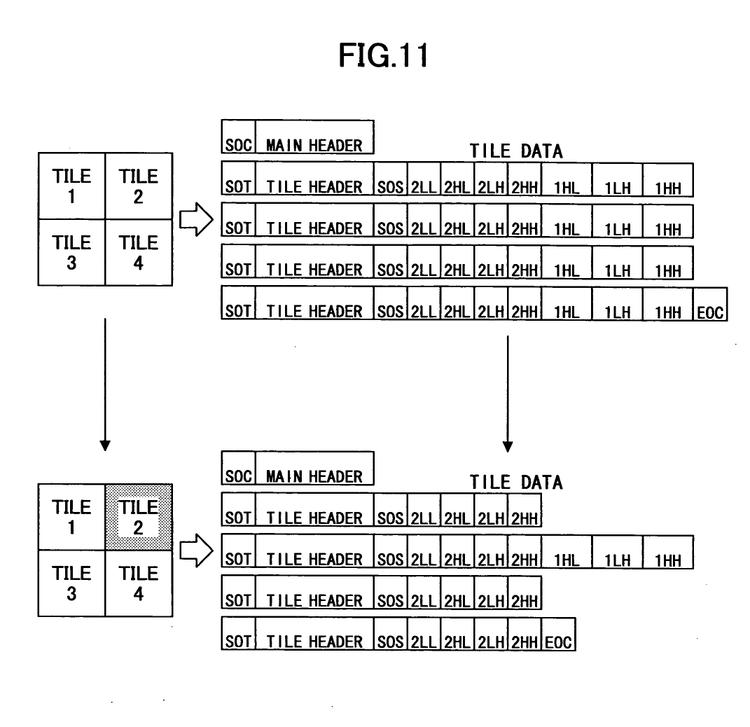

FIG. 11 through FIG. 15 are illustrative drawings for illustrating an example of code structure and code reduction with respect to each progressive method.

FIG. 11 is an illustrative drawing for illustrating the resolution progressive method. In this example, division into four tiles (tile=block) is made, and coding is performed for two hierarchical levels. When the state of a network connection is good, the codes of all the hierarchical levels of each tile are transmitted as shown in the upper part of the drawing. When the state of a network connection deteriorates, the codes of sub-bands at the lower hierarchical level (decomposition level 1) are discarded in three tiles (blocks of no interest) other than the tile 2 that is the block of interest. In this example, the codes of all the sub-bands are discarded at the decomposition level 1. Alternatively, the codes of the sub-bands 1HH, 1LH, and 1HL may be discarded in the order named, depending on how much the state of a network connection deteriorates. Further, if the state of a network connection deteriorates further, provision may be made to discard the codes of the sub-bands 2HH, 2LH, and 2HL at the decomposition level 2 in the order named. In this example, the codes of the block of interest are not discarded at all. Alternatively, the codes of the sub-band 1HH, for example, may be discarded in the block of interest also, thereby achieving code reduction. It should be noted, however, that code reduction is made such that the worse the state of a network connection (reception environment in a broader sense), the larger the difference in the amount of code reduction between the block of interest and the blocks of no interest. Furthermore, the discarding of codes does not have to be performed in the units of sub-bands. For example, code reduction may be made such that codes are discarded from lower-order bit-planes on a bit-plane-by-bit-plane basis in a sub-band.

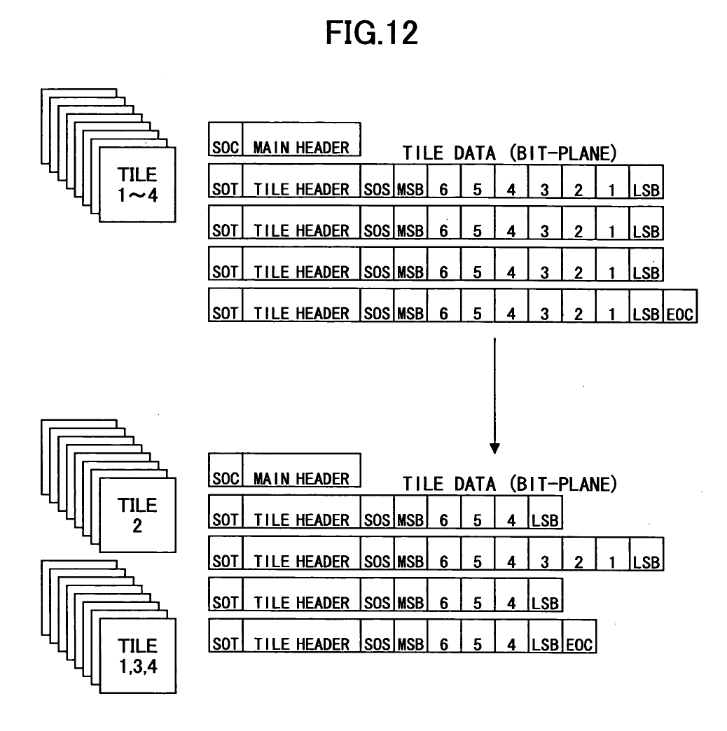

FIG. 12 is an illustrative drawing for illustrating the image quality progressive method. In this example, division into four tiles (tile=block) is made for coding, and codes are arranged in the bit-plane sequence with the highest-order bit-plane first on a bit-plane-by-bit-plane basis. When the state of a network connection is good, the codes of all the hierarchical levels of each tile are transmitted as shown in the upper part of the drawing. When the state of a network connection deteriorates, the codes of lower-order bit-planes (three bit-planes in this example) are discarded in three tiles (blocks of no interest) other than the tile 2 that is the block of interest, as shown in the lower part of the drawing. In this example, the codes of the block of interest are not discarded at all. Alternatively, the codes of lower-order bit-planes may be discarded in the block of interest also, thereby achieving code reduction. It should be noted, however, that code reduction is made such that the worse the state of a network connection (reception environment in a broader sense), the larger the difference in the amount of code reduction between the block of interest and the blocks of no interest. Furthermore, the discarding of codes may be performed in the units of sub-bit-planes rather than in the unit of bit-planes.

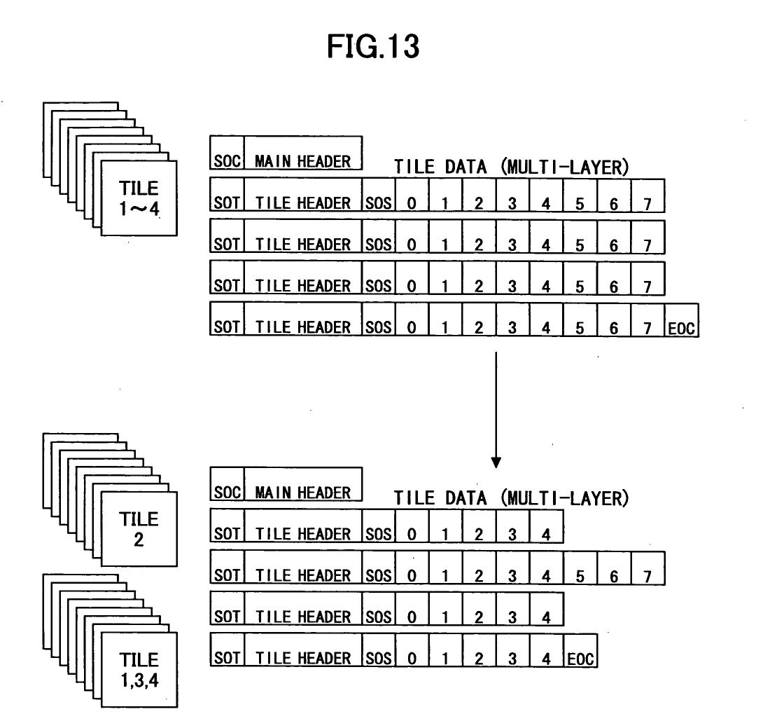

FIG. 13 is another illustrative drawing for illustrating the image quality progressive method. In this example, codes are provided in the multi-layered structure, and are arranged in the layer sequence with the highest-order layer first on a layer-by-layer basis. When the state of a network connection is good, the codes of all the layers of each tile are transmitted as shown in the upper part of the drawing. When the state of a network connection deteriorates, the codes of lower-order layers (three layers in this example) are discarded in three tiles (blocks of no interest) other than the tile 2 that is the block of interest, as shown in the lower part of the drawing. In this example, the codes of the block of interest are not discarded at all. Alternatively, the codes of lower-order layers may be discarded in the block of interest also, thereby achieving code reduction. It should be noted, however, that code reduction is made such that the worse the state of a network connection (reception environment in a broader sense), the larger the difference in the amount of code reduction between the block of interest and the blocks of no interest.

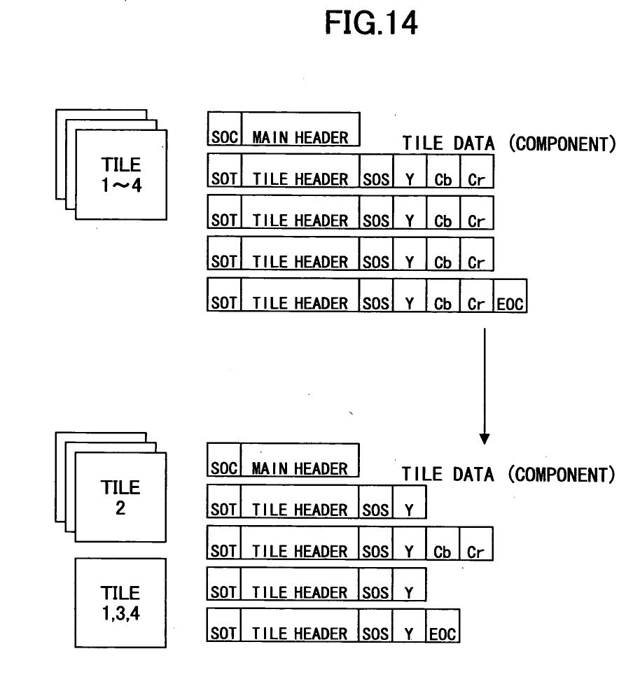

FIG. 14 is an illustrative drawing for illustrating the component progressive method. In this example, division into four tiles (tile=block) is made for coding, and codes are arranged in an order of Y (luminance), Cb, and Cr (color difference) on a component-by-component basis. When the state of a network connection is good, the codes of all the components of each tile are transmitted as shown in the upper part of the drawing. When the state of a network connection deteriorates, the codes of Cr and Cb are discarded in three tiles (blocks of no interest) other than the tile 2 that is the block of interest, as shown in the lower part of the drawing. Needless to say, code reduction may be configured such as to discard the codes of color difference by the units of bit-planes.

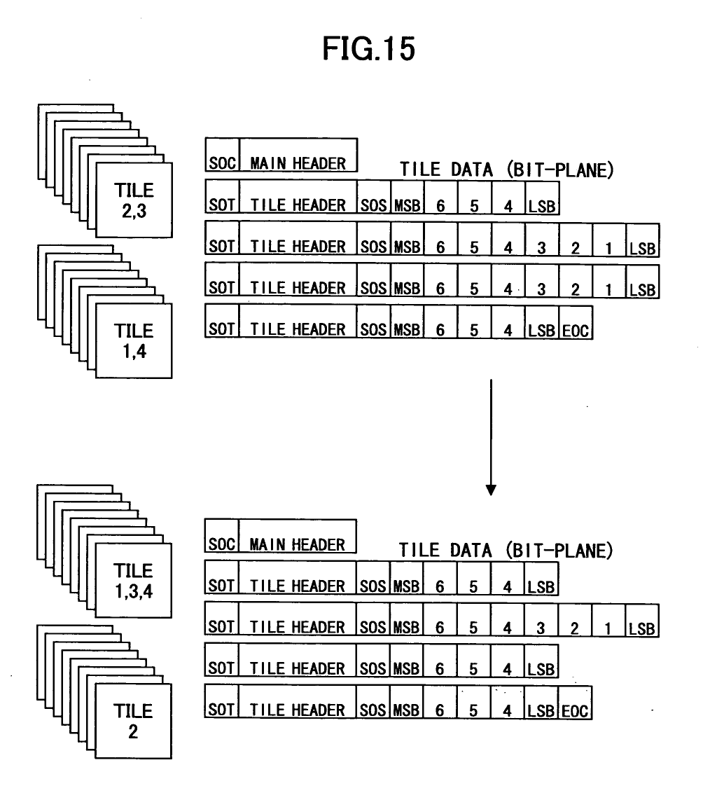

FIG. 15 is an illustrative drawing for illustrating the position progressive method. In this example, the tile is equal to the block, and the codes of each tile are arranged in the bit-plane sequence with the highest-order bit-plane first on a bit-plane-by-bit-plane basis. That is, the code structure is the same as that of FIG. 12 (if a precinct is treated as a block, for example, the codes of each tile are arranged on a precinct-by-precinct basis). When the state of a network connection is slightly poor, the tiles 2 and 3 are treated as the blocks of interest, and the tiles 1 and 4 are treated as the blocks of no interest, with the codes of the three lower-order bit-planes being discarded in the blocks of no interest, as shown in the upper part of the drawing. When the state of a network connection deteriorates further, only the tile 2 is treated as the block of interest, and the three other tiles are treated as the blocks of no interest, with the codes of the three lower-order bit-planes being discarded in the blocks of no interest, as shown in the lower part of the drawing.

Further, the image server apparatus 101 may be provided with a means to check the status of a network connection with each of the client apparatuses 102, and may perform code reduction control or block classification control as described above in response to the state of a network connection detected by such means. Such embodiment is intended to be part of the invention. Even in this case, the decoding capability reported from a client apparatus 102 or such decoding capability and the state of a network connection may be used as the reception environment.

The image server apparatus 101 and the client apparatuses 102 described above may be implemented by use of a computer such as a personal computer having a communication interface and by use of a program. The individual units included in the apparatuses shown in FIG. 1 may be implemented by one or more programs, and such an embodiment is intended to be part of the invention. With such programs being stored, various information record (memory) media such as a magnetic disc, an optical disc, a magneto-optical disc, and a semiconductor memory device are also included by this invention.

Furthermore, it is also possible to cause a computer to execute a program to perform the procedure of the moving image delivery method of the invention in the image server apparatus 101, i.e., to perform at least steps S1 and S4 shown in FIG. 4. A program for this purpose and various information record (memory) media having such program stored therein are also part of the invention.

Further, the present invention is not limited to these embodiments, but various variations and modifications may be made without departing from the scope of the present invention.

The present application is based on Japanese priority application No. 2003-327631 filed on Sep. 19, 2003, with the Japanese Patent Office, the entire contents of which are hereby incorporated by reference.

1. An apparatus for delivering moving images to a client apparatus, comprising:
a unit to acquire an indication of a reception environment of the client apparatus;
a block classifying unit to classify blocks of a still image corresponding to each frame of the moving images into one ore more blocks of interest and one or more blocks of no interest in response to importance of the respective blocks; and
a coding unit to encode the still image corresponding to each frame of the moving images, the coding unit reducing codes with respect to the blocks of no interest ahead of the blocks of interest,
wherein an amount of the code reduction is increased on a block-specific basis as the reception environment deteriorates.

2. The apparatus as claimed in claim 1, wherein the coding unit is configured to increase a difference in an amount of code reduction between the blocks of interest and the blocks of no interest as the reception environment deteriorates.

3. The apparatus as claimed in claim 1, wherein the block classifying unit increases a number of the blocks of no interest as the reception environment deteriorates.

4. The apparatus as claimed in claim 1, wherein the coding unit to increases a difference in an amount of code reduction between the blocks of interest and the blocks of no interest as the reception environment deteriorates if the coding unit generates codes according to one of a resolution progressive method, an image quality progressive method, and a component progressive method, and the block classifying unit increases a number of the blocks of no interest as the reception environment deteriorates if the coding unit generates codes according to a position progressive method.

5. The apparatus as claimed in claim 1, wherein the block classifying unit assigns the importance to the blocks of the still image such that the importance increases towards a center of the still image.

6. The apparatus as claimed in claim 1, wherein the block classifying unit assigns the importance to the blocks of the still image such that the larger an amount of motion in a given block, the larger the importance in the given block is.

7. The apparatus as claimed in claim 1, further comprising a unit to acquire an instruction regarding block importance from the client apparatus, wherein the block classifying unit assigns the importance to the blocks of the still image according to the instruction.

8. The apparatus as claimed in claim 2, further comprising a unit to acquire an instruction regarding the difference in the amount of code reduction between the blocks of interest and the blocks of no interest, wherein the coding unit controls the difference in the amount of code reduction between the blocks of interest and the blocks of no interest according to the instruction.

9. The apparatus as claimed in claim 8, wherein the instruction is given independently for each of the blocks.

10. The apparatus as claimed in claim 3, further comprising a unit to acquire an instruction regarding a difference in a number of blocks between the blocks of interest and the blocks of no interest, wherein the block classifying unit controls the difference in the number of blocks between the blocks of interest and the blocks of no interest according to the instruction.

11. The apparatus as claimed in claim 10, wherein the instruction is given independently for each of the blocks.

12. The apparatus as claimed in claim 4, further comprising:
a unit to acquire a first instruction regarding block importance from the client apparatus;
a unit to acquire a second instruction regarding the difference in the amount of code reduction between the blocks of interest and the blocks of no interest; and
a unit to acquire a third instruction regarding a difference in a number of blocks between the blocks of interest and the blocks of no interest,
wherein the block classifying unit assigns the importance to the blocks of the still image according to the first instruction, the coding unit controlling the difference in the amount of code reduction between the blocks of interest and the blocks of no interest according to the second instruction if the coding unit generates codes according to one of the resolution progressive method, the image quality progressive method, and the component progressive method, and the block classifying unit controlling the difference in the number of blocks between the blocks of interest and the blocks of no interest according to the third instruction if the coding unit generates codes according to the position progressive method.

13. The apparatus as claimed in claim 4, further comprising a unit to acquire an instruction regarding a progressive method, wherein the coding unit generates codes according to a progressive method corresponding to the instruction.

14. The apparatus as claimed in claim 1, wherein the reception environment includes at least one of a state of a network connection with the client apparatus and a decoding capability of the client apparatus.

15. An apparatus for receiving moving images from the apparatus of claim 12, comprising a graphical user interface to display a field to receive the first instruction, the second instruction, and the third instruction.

16. A system, comprising:
the apparatus of claim 1; and
the apparatus of claim 15.

17. A method of delivering moving images to a client apparatus, comprising:
classifying blocks of a still image corresponding to each frame of the moving images into one ore more blocks of interest and one or more blocks of no interest in response to importance of the respective blocks; and
encoding the still image corresponding to each frame of the moving images while reducing codes with respect to the blocks of no interest ahead of the blocks of interest,
wherein an amount of the code reduction is increased on a block-specific basis as a reception environment of the client apparatus deteriorates.

18. The method as claimed in claim 17, wherein encoding the still image increases a difference in an amount of code reduction between the blocks of interest and the blocks of no interest as the reception environment deteriorates.

19. The method as claimed in claim 17, wherein classifying blocks increases a number of the blocks of no interest as the reception environment deteriorates.

20. The method as claimed in claim 17, wherein encoding the still image increases a difference in an amount of code reduction between the blocks of interest and the blocks of no interest as the reception environment deteriorates if encoding the still image generates codes according to one of a resolution progressive method, an image quality progressive method, and a component progressive method, and classifying blocks increases a number of the blocks of no interest as the reception environment deteriorates if encoding the still image generates codes according to a position progressive method.

21. An article of manufacture having one or more recordable media storing instructions thereon which, when executed by a system, cause the system to perform a method comprising:
classifying blocks of a still image corresponding to each frame of the moving images into one ore more blocks of interest and one or more blocks of no interest in response to importance of the respective blocks; and
encoding the still image corresponding to each frame of the moving images while reducing codes with respect to the blocks of no interest ahead of the blocks of interest,
wherein an amount of the code reduction is increased on a block-specific basis as a reception environment of the client apparatus deteriorates.

22. The computer-readable record medium as claimed in claim 21, wherein encoding the still image increases a difference in an amount of code reduction between the blocks of interest and the blocks of no interest as the reception environment deteriorates.

23. The computer-readable record medium as claimed in claim 21, wherein classifying block increases a number of the blocks of no interest as the reception environment deteriorates.

24. The computer-readable record medium as claimed in claim 21, wherein encoding the still image increases a difference in an amount of code reduction between the blocks of interest and the blocks of no interest as the reception environment deteriorates if encoding the still image generates codes according to one of a resolution progressive method, an image quality progressive method, and a component progressive method, and classifying blocks increases a number of the blocks of no interest as the reception environment deteriorates if encoding the still image generates codes according to a position progressive method.
